(19) United States
(12) Patent Application Publication
(10) Pub. No.: US 2016/0357737 A1
(43) Pub. Date: Dec. 8, 2016

(54) NETWORKED MEDIA PLAYER WITH SEARCHING CAPABILITIES

(71) Applicant: Apple Inc., Cupertino, CA (US)

(72) Inventors: Christopher L. Oklota, San Francisco, CA (US); Randall S. Becker, Becker, CA (US); David Pickford, San Jose, CA (US); Christopher Kane, San Jose, CA (US)

(21) Appl. No.: 14/921,726

(22) Filed: Oct. 23, 2015

Related U.S. Application Data
(60) Provisional application No. 62/171,966, filed on Jun. 5, 2015.

(51) Int. Cl. G06F 17/30

(52) U.S. Cl. CPC G06F 17/3005; G06F 17/3002

(57) ABSTRACT

A networked media player includes, in one embodiment, a universal search application that searches for content provided by a plurality of content providers through a corresponding plurality of content provider apps that execute on the networked media players. The search application transmits a search query to one or more servers that search through one or more data structures (e.g. set of indices) containing content from the content providers. The search results are then provided back to the media player and can include at least one canonicalized result and also can include one or more PLAY icons validated through a search using subscription information associated with a cloud subscriber identifier.

This application claims the benefit of U.S. Provisional Patent Application No. 62/171,966 filed on Jun. 5, 2015 which application is incorporated herein by reference.

### BACKGROUND OF THE INVENTION

Existing networked media players, such as the Apple TV from Apple Inc. of Cupertino, Calif., can provide access to multiple content providers such as Netflix, HBO, Showtime as well as access to a user's media library such as a library of songs and/or movies in iTunes. Searching for content is performed within each content provider's domain, so a user must access each domain to search the domain, and switch to another content provider's domain to search another domain.

### SUMMARY OF THE DESCRIPTION

A networked media player includes, in one embodiment, a universal search application that searches for content provided by a plurality of content providers through a corresponding plurality of content provider apps that execute on the networked media player. Each of the content provider apps is configured to present content from the corresponding content provider and can control the presentation of content through a graphical user interface (GUI) that can be unique to that content provider app. The search application is separate and distinct from the plurality of content provider apps and has access to certain information, such as cloud subscriber identifier information and a collection of information about potentially a plurality of different subscriptions from a plurality of different content providers, that the plurality of content provider apps do not, in one embodiment, have access to. The search application receives a search query from a user and transmits the search query to one or more servers that search through one or more data structures (e.g. a set of indices) containing data about the content from the plurality of content providers. The search produces search results that are then transmitted back to the media player, and the search results can include at least one canonicalized search result for content available from a plurality of content providers such that a list of the search results has one entry, instead of two or more entries, for the content available from a plurality of content providers. The canonicalized result can include different icons representing each of the different content providers that can present the same content, and the selection of one of those icons causes the corresponding content provider app to be launched to present the content. The search results can also include one or more icons (e.g. a “PLAY” icon or other indicators) that show that content is currently playable after a verification or validation has been performed by checking or using a locally stored copy (on the media player) of subscription information or a subscription information database maintained for a subscriber on a cloud based data storage system. In one embodiment, the validation can be performed by transmitting, from the networked media player, the search query and subscription information (obtained from the subscription information stored locally on the media player) to one or more servers that perform one or more searches using both the search query and the subscription information, and any matches or hits that include both the search query and the subscription information can be considered content that is currently playable. In another embodiment, the search query includes a cloud subscriber identifier (e.g. an iCloud identifier) that is used with the search query to search the subscription information for that cloud subscriber identifier, and the result of that search can reveal whether that cloud subscriber identifier has a valid subscription that allows presentation of the content.

The various embodiments described herein can be employed in client devices (such as a networked media player) and in server systems and in methods and in systems that use these methods and in non-transitory machine readable storage media that store executable program instructions which when executed can cause a data processing system (such as a client device or a server system) to perform any one or more of the methods described herein.

The above summary does not include an exhaustive list of all embodiments in this disclosure. All systems and methods can be practiced from all suitable combinations of the various aspects and embodiments summarized above, and also those disclosed in the Detailed Description below.

### BRIEF DESCRIPTION OF THE DRAWINGS

The present invention is illustrated by way of example and not limitation in the figures of the accompanying drawings in which like references indicate similar elements.

FIG. 1 shows an example of a system of one or more networked media player devices that are coupled through one or more networks (e.g. the Internet) to one or more server systems that provide for searching for content across multiple content providers.

FIG. 2A is a flowchart showing an embodiment of a method for creating searchable content from a set of catalogs from content providers.

FIG. 2B is a flowchart showing an embodiment of a method for processing a search query from one or more networked media players.

FIG. 3A is a flowchart that shows an embodiment of a method for distributing applications for use with different content providers.

FIG. 3B is a flowchart that shows an embodiment of a method for using subscription information when processing a search query from a networked media player that has an associated subscriber information.

FIG. 4A is a flowchart that shows an embodiment of a method for creating and uploading subscription information for use by one or more networked media players.

FIG. 4B shows a flowchart that illustrates an embodiment of a method for performing a search for content at a networked media player.

FIG. 5 shows an example of a user interface of the results of a search that is displayed on a display device (e.g. a TV) by a networked media player, where the results include at least one canonicalized result where the same content is available from a plurality of content providers.

FIG. 6 shows an example of a system which includes one or more networked media players that are coupled through one or more networks to speech recognition systems that allow for searching by speech recognition.

FIG. 7 shows an example of a method for searching by speech recognition using, for example, the system of FIG. 6.

FIG. 8 shows an example of a transition from a first search result to a second search result.

FIG. 9 shows an example of a data processing system which can be any one of the systems described herein, such as a media player or a server system.

### DETAILED DESCRIPTION

Various embodiments and aspects will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments.

Reference in the specification to “one embodiment” or “an embodiment” means that a particular feature, structure, or characteristic described in conjunction with the embodiment can be included in at least one embodiment. The appearances of the phrase “in one embodiment” in various places in the specification do not necessarily all refer to the same embodiment. The processes depicted in the figures that follow are performed by processing logic that comprises hardware (e.g. circuitry, dedicated logic, etc.), software, or a combination of both. Although the processes are described below in terms of some sequential operations, it should be appreciated that some of the operations described may be performed in a different order. Moreover, some operations may be performed in parallel rather than sequentially.

At least some of the various embodiments described herein relate to techniques for searching for content that can be presented through a networked media player, and in one embodiment, the networked media player can include a search application that can search, through one or more remote databases, for content presented through a plurality of different content provider apps.

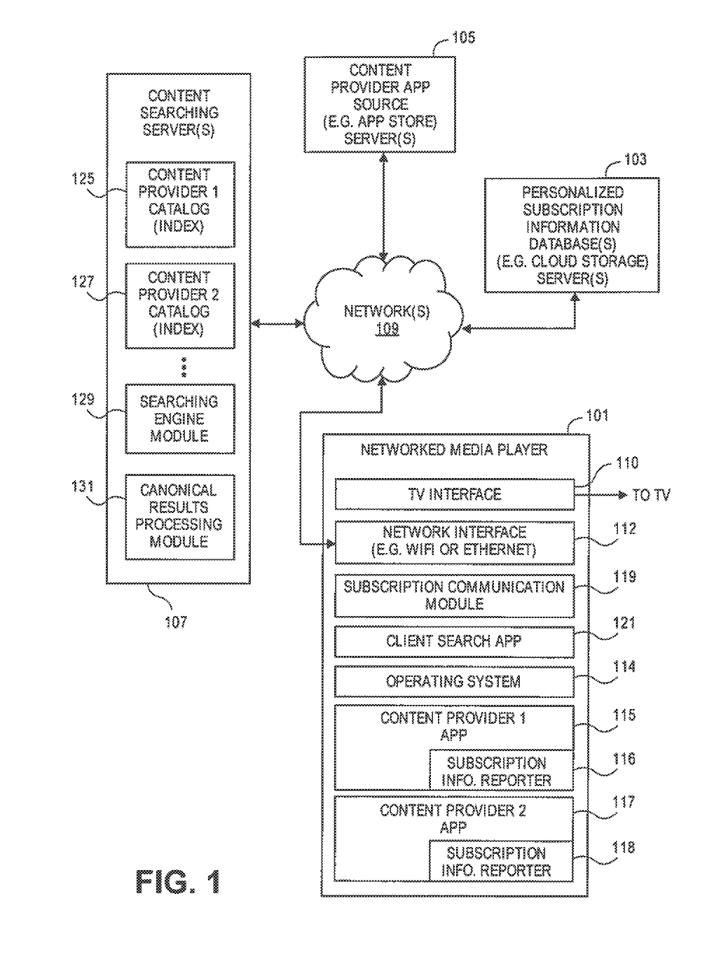

FIG. 1 shows an example of a system of one or more servers 103, 105 and 107 coupled through one or more networks 109 to a networked media player 101. It will be appreciated that a plurality of networked media players can be coupled through the one or more networks 109 to the one or more servers 103, 105, and 107 even though only one networked media player is shown in FIG. 1, and it will be understood that the other networked media players can be similar to the networked media player 101. Networked media player 101 in one embodiment can include a TV input/output interface 110, such as an HDMI interface, to provide output to a display device such as a television (TV) and can also include a network interface 112, such as a WiFi or Ethernet interface to allow the networked media player 101 to transmit and receive through a network such as networks 109 which can include the Internet. The content provider apps on media player 101, such as content provider apps 115 and 117, can retrieve through network interface 112 streaming content from their corresponding content provider and then present (e.g. display video and play audio) that content on a TV (or other display device) through TV interface 110. The network interface 112 allows the networked media player 101, in one embodiment, to transmit search queries to and receive responsive search results from the content searching server(s) 107, and the network interface 112 allows the networked media player 101 to request and receive one or more content provider apps from the content app provider source 105 (which can be a general app store or an app store for one or more content provider apps).

The content provider apps can each be specific to and dedicated to a specific content provider. For example, a content provider such as HBO (or Showtime, etc.) can provide their own specific content provider app that presents (e.g., plays and displays) only content from that particular content provider (and content from other content providers is obtained through other content provider apps). This specificity allows a content provider to uniquely control through their own content provider app, how the content is presented and controlled (e.g., the GUI of the interface, the security and protection of the content through encryption, etc.). Each content provider app, such as content provider apps 115 and 117, can be obtained and downloaded from server(s) 105 to a networked media player or be pre-installed (e.g. installed when manufactured before delivery to a user/consumer) on a networked media player. In one embodiment, a set of content provider apps can be preinstalled on a networked media player and another set of content provider apps can be installed, by the user (after the user acquires the player) from an app store such as server(s) 105. Examples of app stores include the Apple App store and the Google Play store. Both the preinstalled and the user installed apps can be updated after they are installed by downloading updated apps from an app store such as server(s) 105 or from another source for such updates.

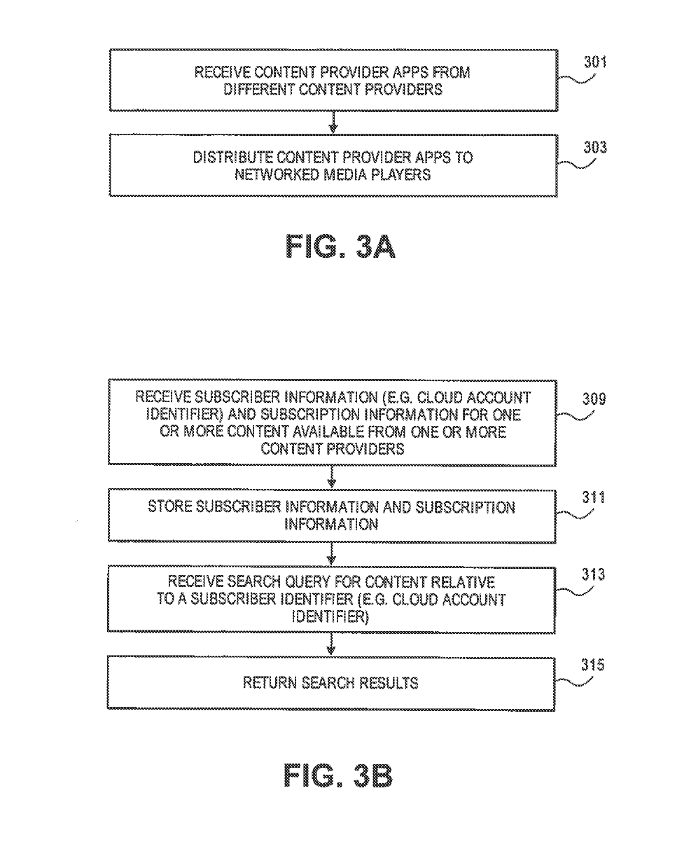

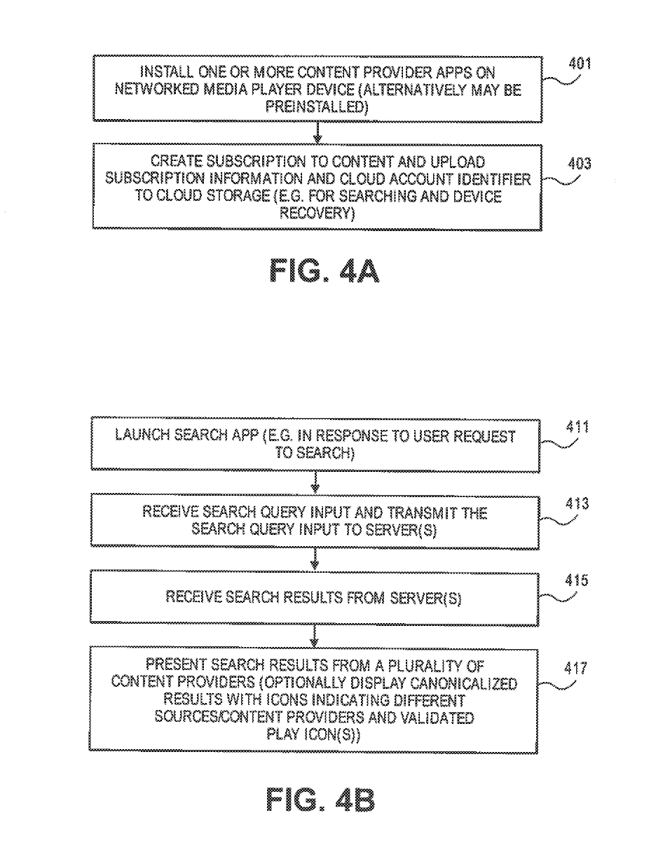

The content provider apps, such as apps 115 and 117 on the media player 101, can include software instructions, such as subscription info reporter 116 and 118 respectively, that can interoperate with subscription communication module 119 to report subscription information to one or more subscription information databases, such as a cloud based servers 103 that can store user information (e.g. calendars, contact, documents, and media recovery information such as songs and/or movies purchased from iTunes store or other media/content sources) as well as subscription information relating to one or more subscriptions to content from the content providers associated with, for example, content provider apps 115 and 117. In one embodiment, the subscription information for content from a content provider is created by that content provider's app when the user buys or otherwise obtains, through that content provider's app, a subscription to one or more content from that content provider, and that content provider's app uses its subscription info reporter to provide the new or updated subscription information to the subscription communication module 119 which in turn causes the subscription information to be transmitted to one or more cloud storage servers 103 for storage and for use in searching as described herein. The subscription communication module 119 has access to the user's cloud subscriber identifier at least in that the module 119 can cause the media player 101 to transmit that identifier to the cloud storage servers 103 along with the subscription information so that the subscription information is associated with that user's cloud subscriber identifier; in one embodiment, the content provider app does not have access to the user's cloud subscriber identifier or to any other subscription information for subscriptions to content from other content providers. In one embodiment, when a user launches a content provider app, such as content provider app 115 or app 117, the user can buy, otherwise obtain, or update a subscription to the content provided through that app; the subscription can be for specific content from that content provider or a subset of the content from that content provider or all of the content from that content provider. The subscription can be limited in time (e.g. a 1 year subscription) and may be limited in other ways. The specifics of the subscription information are created by the launched content provider app and then passed to module 119 by the subscription info reporter so that the module 119 can cause the subscription information (and the associated cloud subscriber identifier) to be uploaded to the server(s) 103. Once that information is stored on server(s) 103, it can be searched, in one embodiment, to provide search results and to also provide one or more indicators (e.g. a PLAY icon) that content (in the search results) has been validated to be playable as the subscription is valid. In another embodiment, rather than searching the subscription information on servers 103 to provide search results, the networked media player keeps a local copy, in its non-volatile storage, of all of the subscription information and can synchronize its local copy with the cloud storing service (servers 103) to maintain a current copy (across all synchronized devices of the user) of the subscription information, and the media player automatically appends its subscription information, from its local copy, to the search query, and the combination of the search query and the appended subscription information is used to search the indices on one or more servers 107. Further information about how the subscription information is used is also provided in conjunction with FIGS. 3B and 4A. In one embodiment, the cloud storage servers 103 store one or more databases for a plurality of cloud subscribers, each of which is specified by a unique cloud subscriber identifier (e.g. joe.montana@iCloud.com) and the data for each cloud subscriber can include calendar data, contact data, documents, photos, content or media purchased (e.g. songs or movies, etc.) on a media store (e.g. iTunes store), apps purchased on an app store, as well as the subscription information (e.g. Netflix subscription information) provided through the content provider apps (e.g. the Netflix app) on the devices of the cloud subscribers. In one embodiment, the servers 103 can sync this data across multiple devices of each cloud subscriber, and the servers 103 can implement a service such as the iCloud service from Apple Inc. Thus, a cloud subscriber can purchase a subscription to content from a content provider (e.g. the XYZ network) on a first device, have its subscription information uploaded to server 103, and then the user can do a search for content from that content provider on another device of the user (having the same cloud subscriber identifier as the first device) and the search results on the another device can include validated PLAY icons.

Networked media player 101 also includes a client search app 121 and an operating system 114. The search app 121 provides, through its interaction with server(s) 107 and server(s) 103, the ability to perform searches for content across a plurality of content providers using a single search query and also using subscription information and other information synchronized with or available from the cloud storage server(s) 103. The search app 121 can transmit the search query (and the appended subscription information) to server(s) 107 and then receive the search results and rank them (unless they were ranked on the server's side) and display them on a TV or other display device. An icon for the search app 121 can be displayed on a home screen of the user interface of the media player, and that search app 121 can be invoked by selecting the icon to launch the search app 121. The home screen may in one embodiment include icons for other apps including content provider apps such as apps 115 and 117. The media player 101 also includes an operating system 114 which manages processes and memory and other hardware and allows the apps to intercommunicate through an interprocess communication (e.g. when a subscription info reporter provides subscription information to the subscription communication module 119).

Content searching servers 107 are a set of one or more servers that provide for searching of the content of various catalogs of content providers, and this content can include movies, TV shows, and other entertainment or content. In one embodiment, the content providers can include providers such as HBO, Showtime, ESPN, iTunes, and other known content providers. The content searching servers 107 can include one or more indices which can be implemented as inverted indices to allow for rapid searching for content in response to a search query provided by a networked media player, such as networked media player 101, to the content searching servers 107 through the one or more networks 109. In the example shown in FIG. 1, each content provider catalog is processed to create a single index or a set of indices for a particular content provider. In particular, the index for content provider 1 is shown as index 125 and the index for content provider 2 is shown as index 127. The index 125 is an inverted index in one embodiment of metadata about the content provided by the content provider 1, while the index 127 is an index of metadata about the content provided by content provider 2. In one embodiment, a variety of different metadata may be included for each item of content in the index. For example, in the case of a movie, the metadata can include an identifier of the content provider (which can be matched against the appended subscription information), a movie's title, the actors in the movie, the director in the movie, the producer, the length of the movie, and other well known metadata describing a movie. All of this metadata can be stored in an index for the content provider. The content searching servers 107 also include a searching engine module 129 which receives search queries from one or more networked media players, such as networked media player 101 and performs searches through the indices of the different content provider catalogs. In an alternative embodiment, the catalogs from various content providers may be collapsed into a single index that is searched by the searching engine module 129. In one embodiment, the content searching servers 107 can also include a canonical results processing module 131 which is configured to produce canonicalized results such that content that is duplicated across different content providers is presented once in the search results listing rather than multiple times. Further details with respect to processing search results to provide canonicalized results is provided further below.

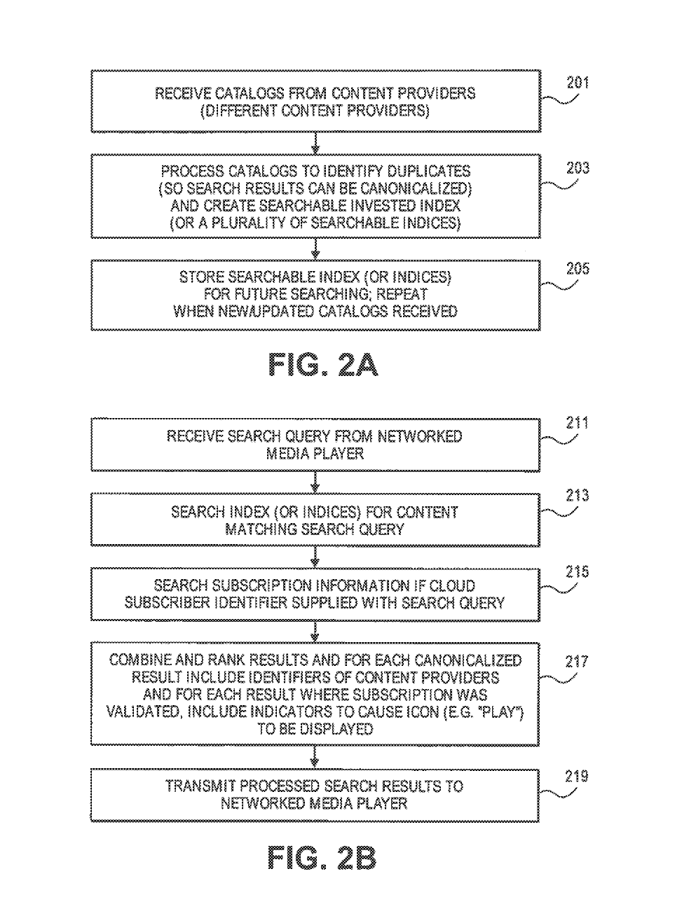

FIG. 2A shows an example of a method according to one embodiment for generating the one or more indices of content for each content provider, such as the indices 125 and 127 shown in FIG. 1. In operation 201 of FIG. 2A, a data processing system receives catalogs from the various content providers; each catalog contains a plurality of metadata for each content item, and that metadata can be used to create an inverted index as is known in the art to allow for rapid searching of the content from the different content providers. This metadata can include, in the case of a movie, an identifier of the content provider (which can be matched against the appended subscription information), the title of the movie, the actors of the movie, the director of the movie, the producer of the movie, and other well known metadata that can be used to identify a movie. After the catalogs are received, they can then be processed in operation 203 in which searchable inverted indices are created. In one embodiment, the catalogs are also processed to identify duplicates so that search results can be canonicalized. There are various ways known in the art to produce canonicalized search results so that only a single listing for a particular content item, which is duplicated across multiple content providers, is shown in a search result. A standardized description of content (e.g. title; actors; director, producer, etc.) can be used to compare against other content from other catalogs to identify duplicates. A particular content item can then be marked or tagged (with an identifier) as being duplicated in other catalogs, and this can allow the search engine module 129 to identify from a first such content item in a first catalog all of the other content catalogs that contain the same item. In this particular example which provides canonicalized results, the processing for canonical results is performed in preprocessing operations by the server before the user searches. In alternative embodiments, the processing to achieve canonical results can be performed at search time by the server, such as server 107 or at search time by a client device, such as the network media 101. After the indices have been created in operation 203, they can be stored on the set of one or more servers 107 for future searching in response to search queries from media players, such as the networked media player 101. In one embodiment, one of the content provider catalogs can be the iTunes store catalog which includes songs, movies, apps, and other content. Records of purchases of such content can be stored for each cloud subscriber identifier associated with those purchases on the servers 103 as described herein. This storage of purchased content can be used to recover a device which has been wiped clean (e.g. erased) so that the device can be restored to its condition prior to being wiped clean as is known in the art.

The servers 105 shown in FIG. 1 can be configured to be a source of content provider apps, and in one embodiment can be an app store that provides the content provider apps and potentially other apps as well such as games, and other types of apps for execution on a networked media player, such as the networked media player 101 or other devices.

FIG. 3A shows a method that can be performed by the servers 105 when they operate as a source for content provider apps. In operation 301, one or more data processing systems can receive the content provider apps and potentially other apps from other sources of apps (e.g. game apps), and these content provider apps can be stored for later distribution to one or more servers, such as the servers 105 shown in FIG. 1. In operation 303, the servers 105 can distribute the content provider apps to networked media players, such as the networked media players through a network, such as network 109. In one embodiment, the distribution of the content provider apps can be in response to an on demand request from a user who has browsed through a catalog of apps to select a particular app, such as a content provider app for showing movies, TV shows, etc. In one embodiment, there may exist a content provider app from HBO and another content provider app from Showtime and other content provider apps from other content providers that are known in the art. The distribution of these various content provider apps can be by way of downloads from the servers 105 through network 109 to the networked media players such as networked media player 101. In certain embodiments, the content provider apps can be preinstalled on a networked media player and then updated periodically or when changes are needed. In one embodiment, a group of content network providers apps may be preinstalled on networked media players and then updates to those are apps are downloaded from the servers 105.

The servers 103 provide a cloud based storage service which stores personalized subscription information as well as potentially other information for each cloud account subscriber which is identified by a cloud account identifier. The content for each cloud subscriber can include calendar data, contact data, documents, photos, content or media purchased on a media store, such as the iTunes store, apps purchased on an app store, such as the Apple App store, as well as subscription information provided through the content provider apps on the devices of a particular cloud subscriber. The servers 103 can synchronize all of this information across all of the devices of a particular cloud subscriber. In one embodiment, the servers 103 can operate in the same fashion as the iCloud service of Apple Inc. of Cupertino, Calif.

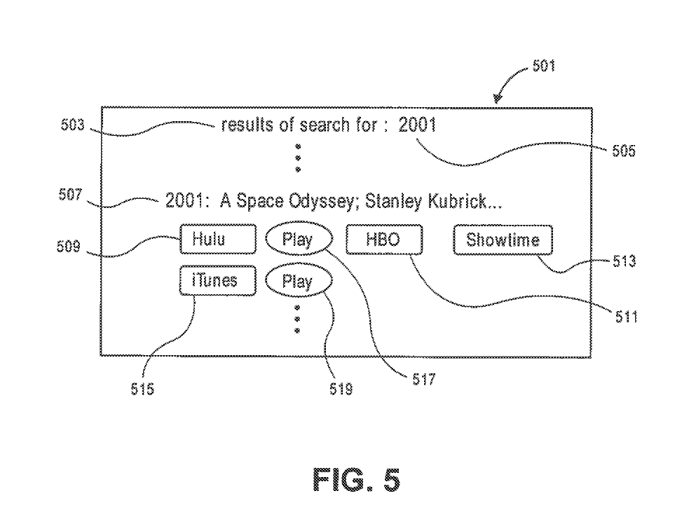

FIG. 3B shows an example of a method performed by servers 103 according to one embodiment. In operation 309, subscriber information, such as a cloud account identifier which specifies a particular subscriber to the cloud storage service, and subscription information for one or more content available from one or more content providers is received by a data processing system associated with the servers 103. This information can be received as a result of the user of a networked media player using a content provider app to buy or otherwise obtain a subscription or update a subscription to content from the content provider associated with the content provider app. The content provider app can, through an API call, call the subscription communication module (e.g. module 119 in FIG. 1) to receive the subscription information, and the subscription communication module can then pass that information along to the one or more servers 103 which receive the subscriber information and the subscription information in operation 309 as described herein. For example, if the content provider app is an app from Netflix, when the user enrolls in Netflix to buy a subscription, the Netflix provider app can then make a call to the subscription communication module 119 which in turn will cause the subscription information for the Netflix content to be uploaded onto the one or more servers 103 and to be stored there for later synchronizing or optionally for searching. Referring back to FIG. 3B, in operation 311, the subscriber information and the subscription information is stored for later synchronizing or optionally for searching. The subscription information stored on servers 103 is not searched, in one embodiment, when a networked media player sends a search query; rather, in that embodiment, the media player appends its local copy of its subscription information with the search query and sends that combination to servers 107 for search and obtains the search results and displays them (e.g. see search results shown in FIG. 5). In an alternate embodiment, the subscription information on servers 103 can be searched in response to a search query and this alternative embodiment is shown in operations 313 and 315 in which a search query is received (the search query being for content relative to a specific subscriber identifier) and search results are returned in operation 315. In one embodiment, the search results can be returned directly from the servers 103 to the networked media player 101; in another embodiment the search results from servers 103 can be returned to the one or more servers 107, where the search results from servers 103 are used with the search query to search through the catalogs by the one or more servers 107 as described herein. The one or more servers 107 can then return the search results to the networked media player that transmitted the search query.

FIG. 4A provides an example of a method performed by a networked media player, such as networked media player 101, wherein the method provides subscription information to, for example, the servers 103 shown in FIG. 1. In operation 401, one or more content provider apps are installed on a networked media player device. This can occur in response to a user browsing for apps on an app store, such as the app store implemented by servers 105 shown in FIG. 1, and selecting one of the apps on the app store and causing it to be downloaded and installed onto the networked media player, such as the media player 101 shown in FIG. 1. In another embodiment, the content provider apps may be preinstalled, and only updates to those apps are downloaded from the app store servers, such as app store 105 shown in FIG. 1. Then in operation 403, a user can create a subscription to content provided by the particular content app (which in turn creates subscription information for that subscription) and upload that subscription information along with a cloud account identifier to a cloud storage service, such as the servers 103. These servers can then be used for searching subscription information (in the alternative embodiment of operation 313) and also for device recovery as described herein.

The processes for searching in one embodiment through the data stored on servers 107 (and 103 in the alternative embodiment) will now be described by referring to FIGS. 2B and 4B. FIG. 2B shows the processes performed by the servers while FIG. 4B shows the processes performed by a networked media player, such as the networked media player 101. As shown in FIG. 2B, the process can begin in operation 211 in which a search query is received from a networked media player. This receipt of the search query can occur as a result of operations 411 and 413, shown in FIG. 4B in which a launched search app receives the search query input and transmits the search query input to the servers 107 (and 103 in the alternative embodiment). In the alternative embodiment, the search query input is transmitted with a cloud subscriber identifier so that information relative to that identifier can be searched on the servers 103 as described herein. After the search query is received in operation 211, then the service can perform the searches (in the alternative embodiment) depicted in operations 213 and 215 in FIG. 2B. In particular, the servers 107 can search an index or a plurality of indexes for content matching the search query while servers 103 (in the alternative embodiment) can search the subscription information if the cloud subscriber identifier was supplied with the search query. Then in operation 217 the search results can be canonicalized and ranked. In those embodiments in which canonicalized results are provided, the one or more servers can include identifiers of content providers so that the user can see the different content providers for a single listing of the content in the list of search results. In those embodiments in which a validated subscription was found, the search results can also include an indicator to cause an icon, such as a “play” icon, to be displayed on the networked media player. The service, such as server 107 can then transmit, in operation 219 of FIG. 2B, the processed search results to the networked media player. Referring back to FIG. 4B, processing can continue in operation 415 in which the search results are received from the one or more servers and then presented in operation 417. In those embodiments in which canonicalized results were provided, icons indicating the different sources or content providers can be included with the search result listing for that particular content item so that the user can select one of the different content providers. Moreover, if the embodiment also includes validated play icons or other icons or indicators which indicate that the subscription to the content had been validated such that the content can be played, then a play icon can also be displayed in association with the appropriate content provider for which the subscription was validated. If the user selects one of the search results or selects one of the content provider icons, then this causes the search app to launch the selected content provider app to display or otherwise present the content specified in the search result that was selected by the user.

FIG. 5 shows an example of a search result which includes both a canonicalized result as well as validated play icons indicating that valid subscriptions exist for at least two content providers as shown in the example of FIG. 5. The example of FIG. 5 is one embodiment of the presentation of search results that can occur from operation 417 shown in FIG. 4B. The search results list 501 can include a plurality of matches to the search query; even though only one match is shown in the search results list 501, it will be understood that a plurality of matches may be concurrently displayed in the search results list. The list 510 includes a heading 503 which, in this embodiment, also specifies the search query 505 which in this case was the number 2001. The search query “2001” returned at least one search result shown by the movie title 507. In this embodiment, this particular search result is a canonicalized result in that this particular movie is available from at least four content providers shown by their associated content provider icons 509, 511, 513, and 515. Thus, rather than presenting the same movie title 507 four different times for four different content providers, the search result has been canonicalized into a single listing with icons for the appropriate content providers that can provide this content. If a user selects one of the content provider icons, then the particular selected content provider app will be launched to cause the presentation of the content, such as a movie. In the example shown in FIG. 5, the embodiment also employs validated play icons which have been validated by verifying the subscription information as described herein which validates that the particular content can be played through two content providers and their appropriate content provider apps. In particular, in this case, the validated play icons 517 and 519 indicate that the content providers associated with icons 509 and 515 have valid subscriptions which will allow the user to play the movie shown by movie title 507.

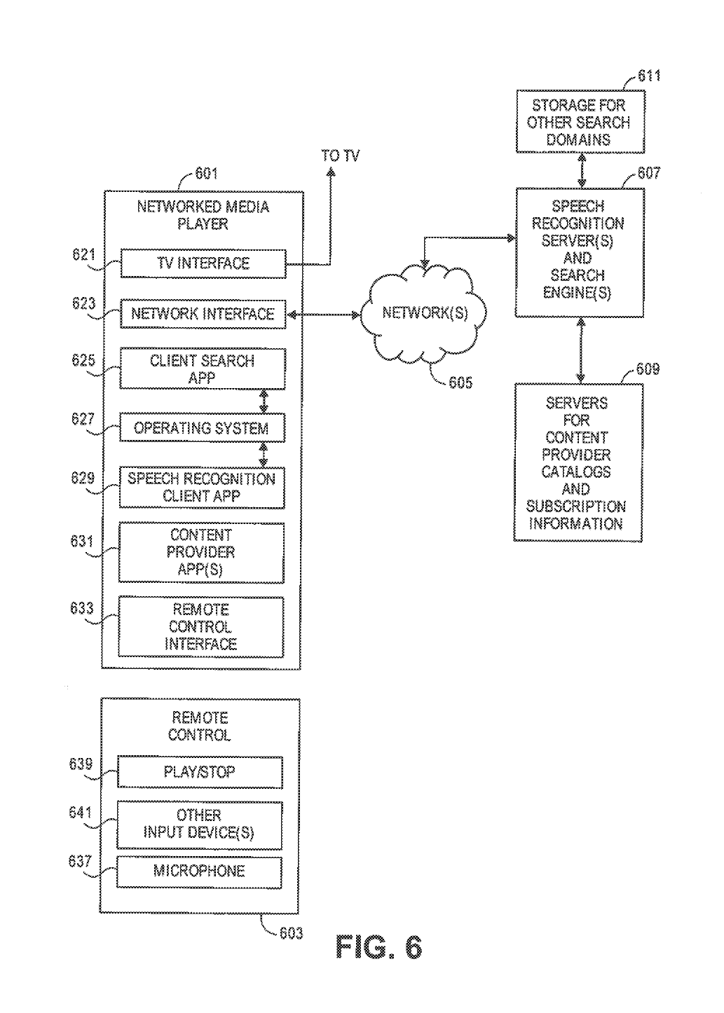

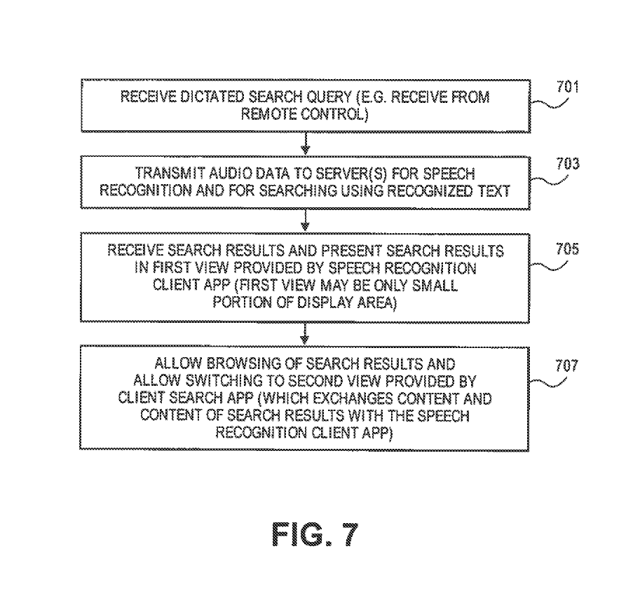

Another aspect of this disclosure relates to searching through speech recognition, and FIGS. 6 and 7, relate to this aspect. FIG. 6 shows an example of interconnected systems, including a networked media player 601 which is similar to the networked media player 101 shown in FIG. 1. The networked media player 601 can include a TV interface 621 which can drive a TV or other display device. The networked media player 601 also includes a network interface 623 which is similar to the network interface 112 and allows the media player 601 to connect through network 605 to the server system 607 and server system 609. In one embodiment, the servers 609 can be similar to the servers 107 and 103. The network 605 can be one or more networks, such as the Internet. The media player 601 can also include a client search app 625 which can be similar to client search app 121 and also include an operating system 627 which can be similar to the operating system 114 in FIG. 1. The operating system 627 can provide for interprocess communication between the client search app 625 and the speech recognition client app 629 as described further below as part of a hand off process between different views when processing search results; further information with respect to this aspect is provided in connection with FIG. 7. The networked media player 601 also includes one or more content provider apps 631 which can be similar to the content provider apps 115 and 117 shown in FIG. 1. The networked media player 601 can also include a remote control interface 633 which is designed to interface with a remote control device 603. The remote control device 603 can control the operation of the media player 601; for example, it can be used to select content, search for content, play or stop content, etc. In one embodiment, the remote control interface 633 may be an infrared transceiver which communicates with the remote control device 603 using conventional infrared communication between a remote control device and another system.

The remote control device 603 can also include its own transceiver (e.g. an infrared transceiver) to interface with the media player 601 through the remote control interface 633. In addition, the remote control device 603 can also include a microphone 637, which can be used to provide speech input which is received by the remote control device 603, digitized and then transmitted through the communication link between the remote control device 603 and the media player 601 to the media player 601. The digitized speech can then be transmitted under control of the speech recognition app 629 through a network 605 to the speech recognition server 607 for processing on those servers to convert the digitized speech into text which can then be used to perform searches, such as searches through the content provider catalogs on servers 107 and through the subscription information on servers 103. The results of the searching using the recognized text can then be returned through the one or more networks 605 to the media player 601 which can then present the results of the search on a TV or other display device. The networked media player 601 can also include a subscriber communication module which is similar to the subscriber communication module 119 and which is used to upload subscriber information and subscription information to the server 609 in a fashion that is similar to what occurs relative to the architecture shown in FIG. 1. In certain embodiments, the remote control 603 can also include play and stop buttons for other input devices such as play and stop buttons 639 to cause playing or stopping respectively of content. Furthermore, the remote control device 603 may include other input devices 641 which can be used by a user such as a touch input pad on the remote control device 603.

FIG. 7 shows an example of a method performed by a media player, such as the media player 601 which can employ speech recognition to perform searches. In operation 701, the media player 601 receives a dictated search query; in one embodiment, this can be received from a remote control, such as the remote control 603 which includes a microphone for receiving the dictated speech query. In one embodiment, the speech can be digitized on the remote control and transmitted through a wireless communication medium to the media player 601. In operation 703, the audio data is transmitted to the speech recognition servers 607 which perform speech recognition to convert the audio data into a recognized text which can then be used for searching on the server(s) 609. In one embodiment, the server(s) 609 include both content catalogs as well as subscription information and thus provide the same functionality as the servers 103 and 107 of FIG. 1. The results of that searching can then be returned in operation 705 in which the media player 601 receives the search results and presents the search results. In one embodiment, the search results are initially presented in a first view which is provided by and controlled by the speech recognition client app. In one embodiment, this first view may be only a small portion of a display area, such as a shelf on the bottom of a display area for displaying a row of icons or other indicia indicating the content which was retrieved as a result of the search query. These search results can be browsed in operation 707 which can also allow switching to a second view provided by the client search app 625. The switch to the client search app which provides the second view involves the exchange of context and content of the search results with the speech recognition client app so that the search results appears to be the same but expanded when switching to the second view. If the user attempts to dictate a further search query while in the second view, then the client search app invokes the speech recognition client app to receive the dictated speech and to transmit that dictated speech to the speech recognition servers 607 and the search results received can then be presented within the second view provided by the client search app. At any one point in time, the user can select any one of the search results to cause the presentation of the content through, for example, the associated content provider app.

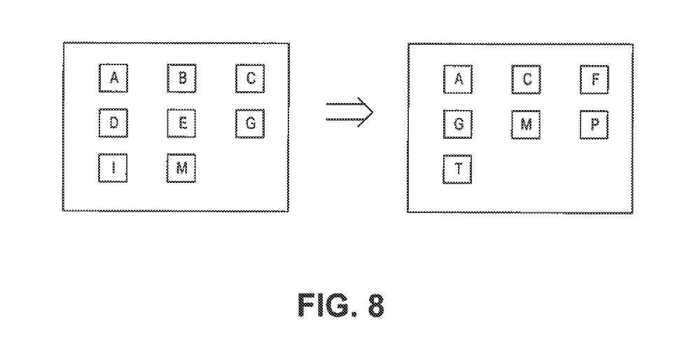

FIG. 8 shows a generalized example of a full screen search result presentation which shows icons of different content. In particular, FIG. 8 shows a transition from a first search result to a second search result which occurred when a user modified an initial search query to create a modified search query which in turn resulted in the addition of additional content and the removal of some of the original content. In one embodiment, the addition and the removal of the icons can occur through animation in which icons, such as icons B and D move off the screen while icons P and T move onto the screen from the periphery of the screen to the final locations. This animation can be driven by an algorithm which describes a series of changes that can be used to transform one ordered list of items into a different ordered list of items.

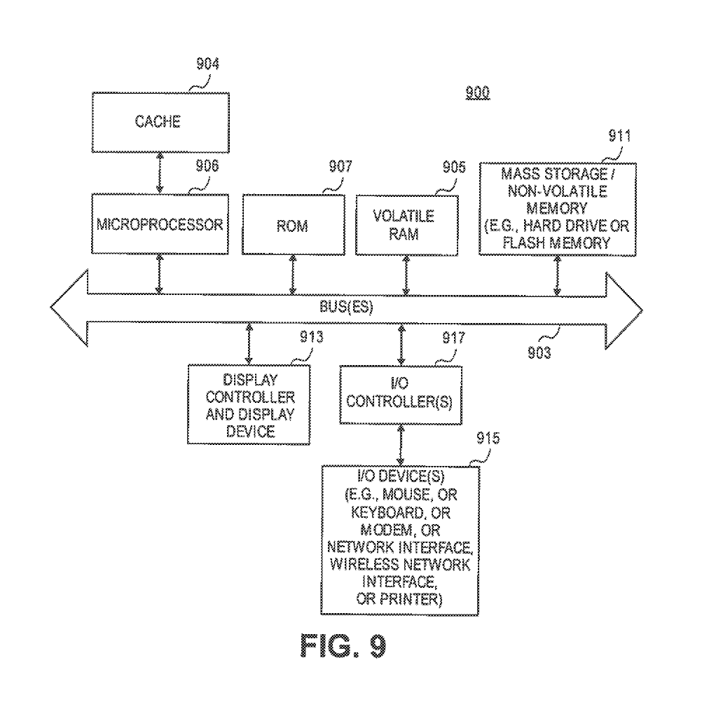

FIG. 9 shows one example of a data processing system, which may be used with any one of the embodiments described herein. Note that while FIG. 9 illustrates various components of a data processing system, it is not intended to represent any particular architecture or manner of interconnecting the components as such details are not germane to this description. It will also be appreciated that network computers, tablet computers, smartphones, laptop computers, desktop computers, other consumer electronic devices and other data processing systems which have fewer components or perhaps more components than those shown in FIG. 9 may also be used with one or more embodiments described herein. The servers described herein can be implemented in a form similar to that shown in FIG. 9, and the networked media players and the remote control described herein can be implemented in a form similar to that shown in FIG. 9.

As shown in FIG. 9, the computer system 900, which is a form of a data processing system, includes a bus 903 which is coupled to one or more microprocessor(s) 906 and a ROM (Read Only Memory) 907 and volatile RAM 905 and a non-volatile memory 911. The microprocessor 905 is coupled to optional cache 904. The microprocessor 906 may retrieve the stored instructions from one or more of the memories 907, 905 and 911 and execute the instructions to perform operations described above. These memories represent examples of machine readable non-transitory storage media that can store or contain computer program instructions which when executed cause a data processing system to perform the one or more methods described herein. The bus 903 interconnects these various components together and also interconnects these components 906, 907, 905 and 911 to a display controller and display device 913 and to peripheral devices such as input/output (I/O) devices 915 which may be one or more of mice, touch screens, touch pads, touch sensitive input devices, keyboards, modems, network interfaces, printers and other devices which are well known in the art. Typically, the input/output devices 915 are coupled to the system through input/output controllers 917. The volatile RAM (Random Access Memory) 905 is typically implemented as dynamic RAM (DRAM) which requires power continually in order to refresh or maintain the data in the memory.

The mass storage 911 is typically a magnetic hard drive or a magnetic optical drive or an optical drive or a DVD RAM or a flash memory or other types of memory system which maintain data (e.g., large amounts of data) even after power is removed from the system. Typically the mass storage 911 will also be a random access memory although this is not required. While FIG. 9 shows that the mass storage 911 is a local device coupled directly to the rest of the components in the data processing system, it will be appreciated that one or more embodiments may utilize a non-volatile memory which is remote from the system, such as a network storage device which is coupled to the data processing system through a network interface such as a modem, an Ethernet interface or a wireless network. The bus 903 may include one or more buses connected to each other through various bridges, controllers and/or adapters as is well known in the art.

In the foregoing specification, specific exemplary embodiments have been described. It will be evident that various modifications may be made to those embodiments without departing from the broader spirit and scope set forth in the following claims. The specification and drawings are, accordingly, to be regarded in an illustrative sense rather than a restrictive sense.

What is claimed is:

1. A non-transitory machine readable medium storing program instructions which when executed by a data processing system cause the data processing system to perform a method comprising:
storing, on a networked media player, a plurality of content provider applications, each from a different content provider, the plurality of content provider applications configured for execution on the networked media player to present content;
launching a search application which is configured to search for content provided through the plurality of content provider applications;
receiving, by the search application, a search query to search for content provided through the plurality of content provider applications;
transmitting the search query to one or more search servers;
receiving, from the one or more servers, search results for the search query;
presenting the search results on a display device coupled to the networked media player.

2. The medium as in claim 1 wherein the method further comprises:
receiving subscription information from at least one of the content provider applications;
transmitting the subscription information and a cloud subscriber identifier, associated with the subscription information, to one or more servers.

3. The medium as in claim 2 wherein the subscription information is used during the searching to create the search results and if a match in the subscription information is found then at least one of the search results includes a validated play icon.

4. The medium as in claim 3 wherein the search results include at least one canonicalized result for content duplicated across a plurality of content providers.

5. A non-transitory machine readable medium storing program instructions which when executed by a system cause the system to perform a method comprising:
receiving content catalogs from a plurality of content providers;
creating one or more indices of content from the content catalogs;
storing the one or more indices on one or more servers for searching in response to search queries from networked media players;
receiving and storing subscription information and associated cloud subscriber identifier from at least one networked media player,
receiving a search query from a networked media player;
searching through the one or more indices using the search query and the subscription information to generate search results in response to the search query;
transmitting the search results to the networked media player.

6. The medium as in claim 5 wherein the networked media player includes a plurality of content provider applications installed on the networked media player, each of the plurality of content provider applications being from a different content provider and configured for execution on the networked media player to present content from the corresponding content provider.

7. The medium as in claim 6 wherein the subscription information comes from at least one of the content provider applications and wherein the search query includes the subscription information, and wherein the plurality of content provider applications do not have access to the associated cloud subscriber identifier or subscription information for subscriptions to other content providers.

8. The medium as in claim 7 wherein the search query is provided by a search application which has access to the subscription information for subscriptions to content from a plurality of content providers and which is different than the plurality of content provider applications.

9. The medium as in claim 6 wherein the search results include at least one canonicalized result for content duplicated across a plurality of content providers and wherein the at least one canonicalized result includes icons indicating different content providers for the same content.

10. The medium as in claim 6 wherein the search results include at least one validated play icon which was validated from the subscription information.

11. The medium as in claim 6, the method further comprising:
receiving apps from the plurality of content providers for distribution to and execution on the networked media players;
transmitting the apps from an app store to the networked media players.
